(19) United States
(12) Patent Application Publication
(10) Pub. No.: US 2023/0400301 A1
(43) Pub. Date: Dec. 14, 2023

(54) TROPICAL INSTABILITY WAVE EARLY WARNING METHOD AND DEVICE BASED ON TEMPORAL-SPATIAL CROSS-SCALE ATTENTION FUSION

(71) Applicants: TIANJIN UNIVERSITY, Tianjin (CN); Qingdao Marine Science and Technology Center, Qingdao (CN)

(72) Inventors: Dan SONG, Tianjin (CN); Zhenghao FANG, Tianjin (CN); Anan LIU, Tianjin (CN); Wenhui LI, Tianjin (CN); Zhiqiang WEI, Qingdao (CN); Jie NIE, Qingdao (CN); Wensheng ZHANG, Qingdao (CN); Zhengya SUN, Beijing (CN)

(21) Appl. No.: 18/133,881

(22) Filed: Apr. 12, 2023

(30) Foreign Application Priority Data
Jun. 10, 2022 (CN) 202210651501.0

(51) Int. Cl. G01C 13/00

(52) U.S. Cl. CPC G01C 13/004

(57) ABSTRACT

The present disclosure discloses a tropical instability wave early warning method based on temporal-spatial cross-scale attention fusion, including performing cross-scale spatial map fusion on the multi-scale feature maps by a bilateral local attention mechanism, calculating a prediction loss by the global feature description map, and combining the prediction loss and the regularization loss for optimization training of neural networks; predicting a sea surface temperature at a moment T based on the optimally trained neural networks, selecting data at K moments before the moment T and inputting the data into the optimally trained neural networks, outputting a predicted value of tropical instability waves by the optimally trained neural networks, and drawing a temporal-spatial image of the tropical instability waves by associating the predicted value with coordinates, so as to achieve early warning of the tropical instability waves. The device includes a processor and a memory.

### CROSS-REFERENCE TO RELATED APPLICATION

This application claims priority from the Chinese patent application 202210651501.0 filed Jun. 10, 2022, the content of which is incorporated herein in the entirety by reference.

### TECHNICAL FIELD

The present disclosure relates to the field of early warning of tropical instability waves, in particular to a tropical instability wave early warning method and device based on temporal-spatial cross-scale attention fusion.

### BACKGROUND

Tropical instability waves are the strongest mesoscale ocean phenomenon in the equatorial cold tongue region of the Pacific Ocean, the motion and development of the tropical instability waves influence large-scale ocean-atmosphere coupling processes such as El Nino and La Nina events (ENSO), and the high-frequency sea current disturbance of the tropical instability waves imposes direct impacts on the hydrology, biochemistry and atmospheric environment in tropics, and has feedback effects on the ocean circulation and ENSO cycle. Sea surface temperatures are closely related to the tropical instability waves, and the development and evolution trend of the tropical instability waves may be grasped by predicting the temporal-spatial distribution of the sea surface temperatures. Yunnan, Guangdong, Hainan, Hong Kong, Macao and Taiwan and other regions of China are located in the tropics, which are vulnerable to the development of the tropical instability waves. Therefore, early warning of the temporal-spatial evolution of the sea surface temperatures related to the tropical instability waves is crucial for human activities such as offshore operations, offshore military activities, navigation, fishery and offshore engineering.

In traditional methods for predicting the tropical instability waves, a numerical simulation method based on a physical equation is usually adopted for performing statistical analysis and modeling on the sea surface temperatures. The tropical instability waves may affect processes such as ocean dynamics, the interaction among atmosphere, ocean and biotic environment and climate change, and meanwhile, transfer of heat, momentum and materials in these processes may also affect the development of the tropical instability waves. To make a model more accurate, the numerical simulation method based on the physical equation needs to consider complex processes, however, it is very difficult to implement such modeling.

In recent years, a deep learning technology based on a deep neural network is developed vigorously, and many mature and effective network structures have emerged, such as convolutional neural networks, recurrent neural networks, generative adversarial networks, and long and short-term memory models. The neural network technology designs a complete network architecture mainly depending on components such as a convolutional layer, a pooling layer, a fully connected layer, and an attention mechanism, which continuously optimizes the networks by extracting features of data, calculating an error by a loss function and updating model parameters by applying a back propagation principle. By means of the method, the features of the data may be learned in an end-to-end manner by repeating the learning over a large amount of data, so that the method is applied based on such features. A large number of research results have shown that deep learning-based modeling is superior to a modeling method based on statistics, numerical calculation or an expert system in the presence of a large amount of data.

The application of the deep learning model in oceanography and other geoscience fields is still in its infancy, so it is necessary to pertinently design deep learning networks targeting at the composition of data elements, forecast scenarios and data features to improve the prediction accuracy and timeliness of the tropical instability waves and alleviate the impacts of the tropical instability waves and secondary disasters thereof on activities such as offshore operations, offshore military activities, navigation, fishery and offshore engineering.

### SUMMARY

The present disclosure provides a tropical instability wave early warning method and device based on temporal-spatial cross-scale attention fusion. In the present disclosure, multi-scale data is extracted by an end-to-end method based on the principle that convolution kernels with different scales have different receptive fields, then attention is paid to spatial information with different scales under different scales by an attention mechanism, and finally cross-scale spatial map fusion is achieved by a bilateral local attention mechanism. The encoding capacity of an algorithm model for spatial information of ocean images in different scales is improved, so as to achieve efficient early warning of tropical instability waves to reduce natural disasters. The detailed description is given as follows:

In a first aspect, a tropical instability wave early warning method based on temporal-spatial cross-scale attention fusion, includes:
up-sampling and down-sampling temporal-spatial data of sea surface temperatures by convolutional and deconvolutional networks based on two-dimensional sea surface temperature images at all moments and all positions to generate multi-scale spatial data;
inputting the multi-scale spatial data into corresponding branch networks to calculate feature maps under corresponding scales, and calculating a regularization loss;
performing cross-scale spatial map fusion on the multi-scale feature maps by a bilateral local attention mechanism, generating a global feature description map, calculating a prediction loss by the global feature description map, and combining the prediction loss and the regularization loss for optimization training of neural networks; and
predicting a sea surface temperature at a moment T based on the optimally trained neural networks, selecting data at K moments before the moment T and inputting the data into the optimally trained neural networks, outputting a predicted value of tropical instability waves by the optimally trained neural networks, and drawing a temporal-spatial image of the tropical instability waves by associating the predicted value with coordinates, so as to achieve early warning of the tropical instability waves.

Wherein the inputting the multi-scale spatial data into the corresponding branch networks to calculate the feature maps under the corresponding scales is specifically as follows:
constructing multi-scale feature network branches, extracting a spatial feature map from each branch network, wherein each branch network CNNₖ consists of five layers of convolutional neural networks, containing three convolutional layers, a maxpooling operation and a multilayer perceptron module;
the three convolution layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.

Wherein the performing cross-scale spatial map fusion on the multi-scale feature maps by the bilateral local attention mechanism is specifically as follows:
constructing a cross-scale attention mechanism to reduce redundant information among feature maps with different scales, generating an attention Aₖ by a softmax layer, and increasing divergence among attentions with different scales by a divergence regularization term, wherein a formula of the divergence regularization term is as follows:

$${A}_{k} = softmax ( \frac{1}{C} {\sum }_{c = 1}^{C} {f}_{t}^{k} )$$

$${l}_{div} ( {A}_{k} , {A}_{1} ) = 1 - sim ( {A}_{k} , {A}_{1} )$$

where, A₁ is an attention feature, l_{div} is a divergence regularization calculation result, and sim is a similarity calculation function.

Furthermore, the regularization loss is:
extracting the feature maps with different scales from the branch networks, calculating the divergence loss according to the divergence regularization term, and optimizing the branch networks by the divergence loss; and a loss function is shown as follows:

L_{reg}=⅓Σₖ₌₁³(½Σₗ₌₁²l_{div}(Aₖ, Aₗ)).

Wherein the performing cross-scale spatial map fusion on the multi-scale feature maps by the bilateral local attention mechanism is specifically as follows:
transforming a large-scale feature map into one with a matched size:

f̅ₜ̅^̅{̅l̅}̅=w_{c}·P(fₜ^{l})
where, P represents a maxpooling operation at an interval of 2, and w_{c} is a parameter of convolution;
matching sizes of the large-scale feature map and the mesoscale feature map, and fusing large-scale information and mesoscale information in a feature map averaging manner to obtain a fused feature map {Fₜ∈R^{C×H×W}}ₜ₌₁^{T}; and
locally decomposing the fused feature map, evenly decomposing Fₜ at each moment into h*w sub-regions, and performing average pooling in the sub-regions to obtain a final fused feature map.

Wherein the calculating the prediction loss by the global feature description map is specifically as follows:
generating time sequence weights by the decomposed feature maps to generate a global feature representation u∈R^{C×1}; generating a channel selection weight according to the global feature representation u:
transforming the feature maps according to the channel selection weight to acquire the global feature map, and calculating the prediction loss by the transformed global feature map:

$${L}_{pre} = {\sum }_{t = 1}^{K} {\sum }_{( m , n ) ∈ {Grids}_{output}} {( {G}_{t} ( m , n ) - S S {T}_{t} ( m , n ) )}^{2}$$

where, m is a subscript of horizontal coordinates, n is a subscript of vertical coordinates, SST is a real tag value at a moment t, and Gridsₒᵤₜₚᵤₜ is the traversal of coordinates of two-dimensional output.

In a second aspect, a tropical instability wave early warning device based on temporal-spatial cross-scale attention fusion, includes:
a module for generating multi-scale spatial data, configured to up-sample and down-sample temporal-spatial data of sea surface temperatures by convolutional and deconvolutional networks based on two-dimensional sea surface temperature images at all moments and all positions to generate the multi-scale spatial data;
a module for calculating a regularization loss, configured to input the multi-scale spatial data into corresponding branch networks to calculate feature maps under corresponding scales, and calculate the regularization loss;
on the multi-scale feature maps by a bilateral local attention mechanism, generate a global feature description map, calculate a prediction loss by the global feature description map, and combine the prediction loss and the regularization loss for optimization training of neural networks; and
a module for early warning of tropical instability waves, configured to predict a sea surface temperature at a moment T based on the optimally trained neural networks, select data at K moments before the moment T and input the data into the optimally trained neural networks, output a predicted value of the tropical instability waves by the optimally trained neural networks, and draw a temporal-spatial image of the tropical instability waves by associating the predicted value with coordinates, so as to achieve early warning of the tropical instability waves.

In a third aspect, a tropical instability wave early warning device based on temporal-spatial cross-scale attention fusion, includes a processor and a memory;
program instructions are stored in the memory, and the processor calls the program instructions stored in the memory to enable the device to implement the steps of the method according to any one of the first aspect.

In a fourth aspect, provided is a computer-readable storage medium storing computer programs, wherein the computer programs include program instructions, and when the program instructions are executed by a processor, the processor implements the steps of the method according to any one of the first aspect.

The technical solutions provided by the present disclosure have the following beneficial effects:
1. The present disclosure considers complex receptive fields while overcoming the defect of the complex modeling process of a traditional numerical modeling or statistical analysis method, and extracts features from multi-scale data.
2. The method applies an end-to-end neural network model, the model can be trained only by providing sea surface temperature data at continuous moments without additional artificial processing, and the method can be rapidly deployed in actual application.
3. The present disclosure encodes the spatial information of the ocean images in different scales to achieve efficient early warning of the tropical instability waves, which is conducive to alleviating impacts of temporal-spatial evolution of the tropical instability waves and secondary disasters thereof on activities such as offshore operations, offshore military activities, navigation, fishery and offshore engineering.

### BRIEF DESCRIPTION OF THE DRAWINGS

FIG. 1 is a flowchart of a tropical instability wave early warning method based on temporal-spatial cross-scale attention fusion;

FIG. 2 is a schematic diagram of generation of multi-scale sea surface temperature spatial data;

FIG. 3 is a structural diagram of branch networks for extracting multi-scale features;

FIG. 4 is a schematic structural diagram of a tropical instability wave early warning device based on temporal-spatial cross-scale attention fusion; and

FIG. 5 is another schematic structural diagram of a tropical instability wave early warning device based on temporal-spatial cross-scale attention fusion.

### DETAILED DESCRIPTION OF THE PRESENT DISCLOSURE

To make the objectives, technical solutions and advantages of the present disclosure clearer, the implementations of the present disclosure will be described in detail below.

### Embodiment 1

A tropical instability wave early warning method based on temporal-spatial cross-scale attention fusion mainly includes four parts: a multi-scale spatial data generation part, a multi-branch feature map extraction part, a cross-scale feature map fusion part and an early warning part.

Wherein different receptive fields are used in the multi-scale spatial data generation part, and the encoding capacity of an algorithm model for spatial information of ocean images in different scales may be improved by a difference among the receptive fields; the multi-branch feature map extraction part is used for extracting feature maps with low information redundancy, so as to further improve the cross-scale prediction capacity of the model; by using a bilateral local attention mechanism, the cross-scale feature map fusion part achieves fusion of cross-scale spatial maps; and in the early warning part, a temporal-spatial image of tropical instability waves is drawn according to calculated values of the tropical instability waves, and early warning of the tropical instability waves is performed in real time according to the temporal-spatial image.

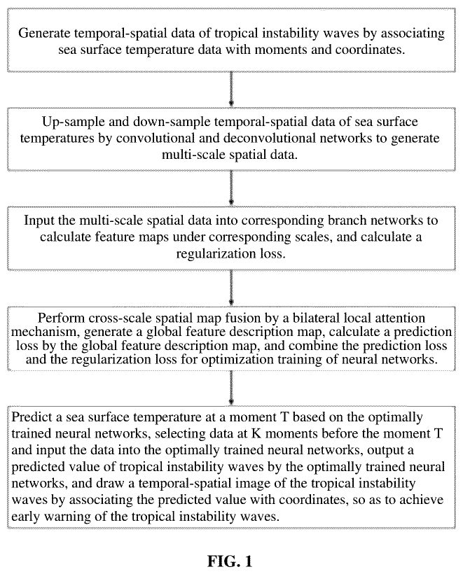

Referring to FIG. 1, a tropical instability wave early warning method based on temporal-spatial cross-scale attention fusion, includes the following steps:
101: temporal-spatial data of sea surface temperatures in a two-dimensional image form is generated according to sea surface temperature data associated with moments and coordinates, and a temporal-spatial database of the sea surface temperatures may be formed after the two-dimensional temporal-spatial images are acquired;
102: the temporal-spatial data of the sea surface temperatures is up-sampled and down-sampled by convolutional and deconvolutional networks after the two-dimensional sea surface temperature images at all moments and all positions are acquired in step 101 to generate multi-scale spatial data;
103: the multi-scale spatial data obtained in step 102 is input into corresponding branch networks to calculate feature maps under corresponding scales, and a regularization loss is calculated;
104: cross-scale spatial map fusion is performed on the multi-scale feature maps obtained in step 103 by a bilateral local attention mechanism, a global feature description map is generated, a prediction loss is calculated by the global feature description map, and the prediction loss and the regularization loss in step 103 are combined for optimization training of neural networks; and
105: a sea surface temperature at a moment T is predicted based on the optimally trained neural networks, data at K moments before the moment T is selected and input into the optimally trained neural networks, a predicted value of tropical instability waves is output by the optimally trained neural networks, and a temporal-spatial image of the tropical instability waves is drawn by associating the predicted value with coordinates, so as to achieve early warning of the tropical instability waves.

In conclusion, the embodiment of the present disclosure considers complex receptive fields while overcoming the defect of the complex modeling process of a traditional numerical modeling or statistical analysis method through the above steps 101 to 105, and extracts features from the multi-scale data; an end-to-end neural network model is applied, which may be trained only by providing sea surface temperature data at continuous moments without additional artificial processing, and the method can be rapidly deployed in actual application; and the prediction accuracy and efficiency of the sea surface temperatures are improved, and then early warning of the tropical instability waves is achieved, thereby alleviating impacts of the tropical instability waves and secondary disasters thereof on activities such as offshore operations, offshore military activities, navigation, fishery and offshore engineering.

### Embodiment 2

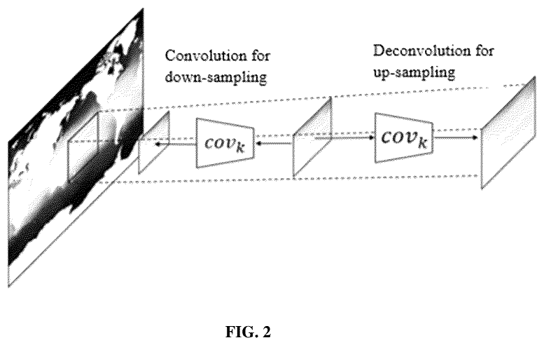

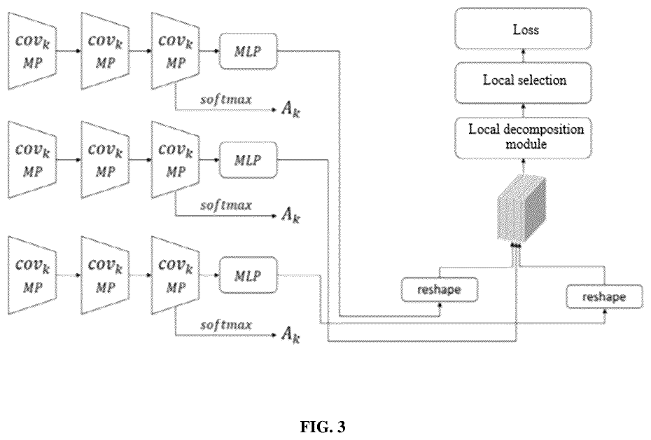

The solution in Embodiment 1 will be further explained below with reference to specific calculation formulas, examples and FIG. 2 to FIG. 3, and the detailed description is given as follows:
201: historical climate observation and simulation datasets are provided by Institute for Climate and Application Research (ICAR).

Wherein data includes historical simulation data in a CMIP5/6 mode and historical observation assimilation data in nearly 100 years reconstructed in a US SODA mode.
202: A time span of sea surface temperature data is selected as 13 years from 2006 to 2019, and this period of time is divided into two non-overlapped time periods from 1 Jan. 2006 to 31 Dec. 2009 and from 1 Jan. 2010 to 31 Mar. 2019, which correspond to train set data Dₜᵣₐᵢₙ and test set data Dₜₑₛₜ respectively;
203: sea surface temperature data at 10° S˜10° N and 180° W˜120° W in the Eastern Equatorial Pacific Ocean are both sampled in the two time periods in step 202, a sampling resolution is 9 km×9 km, 232×696 temperature points are obtained in a region between 10° S˜10° N and 180° W˜120° W in the Eastern Equatorial Pacific Ocean, and sea surface temperatures are sampled by averaging sea surface temperatures in the region corresponding to 9 km×9 km;
204: a two-dimensional image is generated by making the temperature points in step 203 correspond to longitude and latitude coordinates to represent spatial data images of the sea surface temperatures at the corresponding moments, the spatial data images are arranged according to a time sequence in step 202, and temporal-spatial sequence data D={vₛₛₜ∈R^{C×H×W}} of the sea surface temperatures is obtained, where, xₜ represents sea surface temperature image data of the regions at 10° S˜10° N and 180° W˜120° W in the Eastern Equatorial Pacific Ocean at a moment t;
205: the temporal-spatial sequence data D of the sea surface temperatures is up-sampled and down-sampled by convolutional and deconvolutional networks to generate multi-scale spatial data;
wherein temporal-spatial data in three scales is generated in the embodiment of the present disclosure, that is, sizes of convolution kernels may be selected as 2*2, 4*4 and 8*8, and the sizes may be limited according to requirements in actual application during specific implementation, which is not limited in the embodiment of the present disclosure.
206: Convolutional layers are constructed by the convolutional kernels with the above sizes, original data is subjected to multi-scale sampling to obtain multi-scale temporal-spatial data: D={vₜ^{k}∈R^{T×C×H×W}}, namely vₜ^{k}=covₖ(vₛₛₜ), wherein k is the sizes of the convolutional kernels set as 2, 4 and 8;
wherein T is a length of a moment at which data is input; C is the number of channels; H is an image height; W is an image width; vₛₛₜ is temporal-spatial sequence data of sea surface temperatures; and vₜ^{k} is multi-scale temporal-spatial data constructed through the convolutional kernels.

The multi-scale temporal and spatial data is constructed and divided through the above steps 201 to 206.
207: Multi-scale feature network branches are constructed, a spatial feature map is extracted independently from each branch network, and each branch network CNNₖ consists of five layers of convolutional neural networks, containing three convolutional (Cov) layers, a maxpooling (MP) operation and a multilayer perceptron (MLP) module;
wherein the three convolutional layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.
208: Feature maps F={fₜ^{k}∈R^{T×C×H×W}} of temporal-spatial data of corresponding branches are extracted from the branch networks in step 207;
where, fₜ^{k}=CNNₖ(vₜ^{k}), CNN is a multi-scale feature network branch in step 207, and fₜ^{k} is a temporal-spatial data feature extracted from a corresponding CNN.
209: A cross-scale attention mechanism is constructed to a module to reduce redundant information among feature maps with different scales, an attention Aₖ is generated by a softmax layer, and divergence among attentions with different scales is increased by a divergence regularization term, wherein a formula of the divergence regularization term is as follows:

$${A}_{k} = softmax ( \frac{1}{C} {\sum }_{c = 1}^{C} {f}_{t}^{k} ) \qquad ( 1 )$$

$${l}_{div} ( {A}_{k} , {A}_{1} ) = 1 - sim ( {A}_{k} , {A}_{1} ) \qquad ( 2 )$$

where, A₁ is an attention feature, l_{div} is a divergence regularization calculation result, and sim is a similarity calculation function.
210: The feature maps with different scales are extracted from the branch networks, then the divergence loss is calculated according to the divergence regularization term in step 209; the branch networks are optimized by the divergence loss, and a loss function is shown as follows:

L_{reg}=⅓Σₖ₌₁³(½Σₗ₌₁²l_{div}(Aₖ, Aₗ)) (3)

Features may be extracted from the low-redundancy multi-scale feature maps based on step 207 to step 210,; so that the encoding capacity of an algorithm model for spatial information of ocean images in different scales is improved.
211: A sea surface temperature feature map extracted according to the networks in step 208 represents features extracted from the kth branch network at a moment t, firstly, different branch feature maps are fused into one feature map, by taking fusion of two adjacent scale branches as an example, assuming that the feature map output by the large-scale branch is fₜ^{k}∈R^{C×H×W} and the feature map output by the mesoscale branch is

$${f}_{t}^{l} ∈ {R}^{C \times \frac{H}{2} \times \frac{W}{2}} ,$$

and R is a real number space, as for cross-scale fusion, firstly, the large-scale feature map is transformed into one with a matched size:

f̅ₜ̅^̅{̅l̅}̅=w_{c}·P(fₜ^{l})
where, P represents a maximum pooling operation at an interval of 2, and w_{c} is a parameter of convolution. By means of the above formula, sizes of the large-scale feature map and the mesoscale feature map are matched, and large-scale information and mesoscale information are fused in a feature map averaging manner to obtain a fused feature map {Fₜ∈R^{C×H×W}}ₜ₌₁^{T}.
212: The fused feature map is locally decomposed, Fₜ at each moment is evenly decomposed into h*w sub-regions, and average pooling is performed in the sub-regions to obtain a final fused feature map, namely {Fₜ∈R^{T×C×h×w}}.
213: Time sequence weights are generated by the decomposed feature maps in step 212, firstly, a global feature representation u∈R^{C×1} is generated;

u=GAP_{T,h,w}(Σᵢ₌₁^{K}Fᵢ) (5)
where, GAP is an operator of global average pooling, K is the number of scales, which is specifically set to be 3 in the embodiment, and Fᵢ is a regional center feature in step 212.

Then a channel selection weight is generated according to the global feature representation u:

$${g}_{i} = \frac{exp ( {W}_{i} u )}{{\sum }_{i = 1}^{k} exp ( W\_i u )} \qquad ( 6 )$$

where, Wᵢ is an operator matrix, and Wⱼ is an operator matrix.
214: The feature maps are transformed according to the channel selection weight in step 213 to acquire the global feature map is acquired:

Gₜ=Σᵢ₌₁^{K}R(gᵢ)·Fₜ (7)

Transformation from the multi-scale feature maps to the global feature map is achieved through steps 211 to 214, and multi-scale information is fused in the global feature map, so as to obtain more comprehensive information.
215: The prediction loss is calculated by the transformed global feature map:

Lₚᵣₑ=Σₜ₌₁^{K}Σ_{(m,n)∈Grids}_{ₒᵤₜₚᵤₜ}(Gₜ(m,n)−SSTₜ(m,n))² (8)
where, m is a subscript of horizontal coordinates, n is a subscript of vertical coordinates, SST is a real tag value at a moment t, and Gridsₒᵤₜₚᵤₜ is the traversal of coordinates of two-dimensional output.

The regularization loss in step 210 and the prediction loss in step 215 are combined to jointly optimize the neural networks, and a total loss function is shown as follows:

L=L_{reg}+Lₚᵣₑ (9)
216: Assuming that time for which the sea surface temperature is to be predicted is T, data at K moments before the moment T is selected and input into the optimally trained neural networks, a predicted value of tropical instability waves is output by the optimally trained neural networks, a temporal-spatial image of the tropical instability waves is drawn by associating the predicted value with coordinates, and the predicted value is compared with historical early warning threshold values, so as to achieve early warning of the tropical instability waves in combination with image analysis.

In conclusion, in the embodiment of the present disclosure, features are extracted from the multi-scale data by applying complex receptive fields through the above steps 201 to 216: an end-to-end neural network model is applied, which can be trained only by providing sea surface temperature data at continuous moments without additional artificial processing, and the method can be rapidly deployed in actual application; and the prediction accuracy and efficiency of the tropical instability waves are improved, thereby alleviating impacts of temporal-spatial evolution of the tropical instability waves and secondary disasters thereof on activities such as offshore operations, offshore military activities, navigation, fishery and offshore engineering.

### Embodiment 3

The feasibility of the solutions in Embodiment 1 and Embodiment 2 will be further validated below with reference to specific experiments, and the detailed description is given as follows:

### I. Datasets:

This experiment adopts historical climate observation and simulation datasets provided by Institute for Climate and Application Research (ICAR). Data includes historical simulation data in a CMIP5/6 mode and historical observation assimilation data in nearly 100 years reconstructed from a US SODA mode; 1-2265 in 4645 pieces of CMIP data are historical simulation data for 151 years provided by 15 modes in CMIP6 (total: 151 years*15 modes=2265); and 2266-4645 are historical simulation data for 140 years provided by 17 modes in CIMP 5 (total: 140 years*17 modes=2380). The historical observation assimilation data is SODA data provided by the US.

### II. Assessment Standard:

1. MSE is a key index for showing temperature prediction accuracy, by which a prediction effect may be displayed visually.
2. Visual image: a prediction result is transformed into a two-dimensional image, which may visually reflect the prediction effect.

### III. Experimental Results:

It can be shown that in the tropical instability wave early warning method based on temporal-spatial cross-scale attention fusion provided by the present disclosure, data at K moments before a moment T is selected, so as to predict temporal-spatial distribution of the tropical instability waves at the moment T; and a temporal-spatial image of the tropical instability waves is drawn by associating a predicted value with coordinates, and the predicted value is compared with historical early warning threshold values, so as to achieve early warning of the tropical instability waves in combination with image analysis.

### Embodiment 4

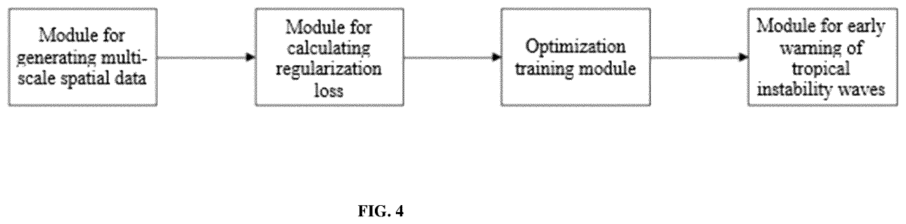

Referring FIG. 4, a tropical instability wave early warning device based on temporal-spatial cross-scale attention fusion, includes:
a module for generating multi-scale spatial data, configured to up-sample and down-sample temporal-spatial data of sea surface temperatures by convolutional and deconvolutional networks based on two-dimensional sea surface temperature images at all moments and all positions to generate the multi-scale spatial data;
a module for calculating a regularization loss, configured to input the multi-scale spatial data into corresponding branch networks to calculate feature maps under corresponding scales, and calculate the regularization loss;
on the multi-scale feature maps by a bilateral local attention mechanism, generate a global feature description map, calculate a prediction loss by the global feature description map, and combine the prediction loss and the regularization loss for optimization training of neural networks; and
a module for early warning of tropical instability waves, configured to predict a sea surface temperature at a moment T based on the optimally trained neural networks, select data at K moments before the moment T and input the data into the optimally trained neural networks, output a predicted value of the tropical instability waves by the optimally trained neural networks, and draw a temporal-spatial image of the tropical instability waves by associating the predicted value with coordinates, so as to achieve early warning of the tropical instability waves.

In conclusion, the prediction accuracy and efficiency of the tropical instability waves are improved by the embodiment of the present disclosure through the above modules, which is conducive to reducing impacts of temporal-spatial evolution of the tropical instability waves and secondary disasters thereof on activities such as offshore operations, offshore military activities, navigation, fishery and offshore engineering.

### Embodiment 5

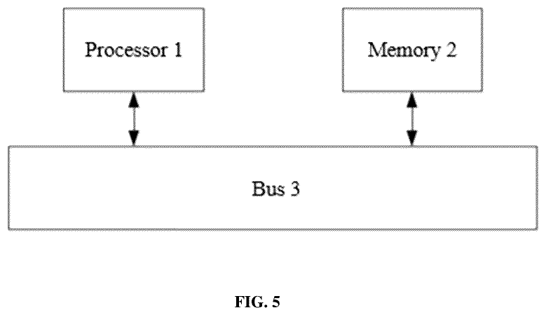

Referring to FIG. 5, a tropical instability wave early warning device based on temporal-spatial cross-scale attention fusion, includes: a processor and a memory storing program instructions, and the processor calls the program instructions stored in the memory to enable the device to implement the steps of the method in Embodiment 1:
sea surface temperature temporal-spatial data is up-sampled and down-sampled by convolutional and deconvolutional networks based on two-dimensional sea surface temperature images at all moments and all positions to generate multi-scale spatial data;
the multi-scale spatial data is input into corresponding branch networks to calculate feature maps under corresponding scales, and a regularization loss is calculated;
cross-scale spatial map fusion is performed on the multi-scale feature maps by a bilateral local attention mechanism, a global feature description map is generated, a prediction loss is calculated by the global feature description map, and the prediction loss and the regularization loss are combined for optimization training of neural networks; and
a sea surface temperature at a moment T is predicted based on the optimally trained neural networks, data at K moments before the moment T is selected and input into the optimally trained neural networks, a predicted value of tropical instability waves is output by the optimally trained neural networks, and a temporal-spatial image of the tropical instability waves is drawn by associating the predicted value with coordinates, so as to achieve early warning of the tropical instability waves.

Wherein the inputting the multi-scale spatial data into the corresponding branch networks to calculate the feature maps under the corresponding scales is specifically as follows:
multi-scale feature network branches are constructed, a spatial feature map is extracted from each branch network, and each branch network CNNₖ consists of five layers of convolutional neural networks, containing three convolutional layers, a maxpooling operation and a multilayer perceptron module; wherein
the three convolutional layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.

Furthermore, the branch networks are:
fₜ^{k}=CNNₖ(vₜ^{k}), and fₜ^{k} is a temporal-spatial data feature extracted from a corresponding CNN.

Wherein the performing cross-scale spatial map fusion on the multi-scale feature maps by the bilateral local attention mechanism is specifically as follows:
a cross-scale attention mechanism is established to reduce redundant information among feature maps with different scales, an attention Aₖ is generated by a softmax layer, and divergence among attentions with different scales is increased by a divergence regularization term, wherein a formula of the divergence regularization term is as follows:

$${A}_{k} = softmax ( \frac{1}{C} {\sum }_{c = 1}^{C} {f}_{t}^{k} )$$

$${l}_{div} ( {A}_{k} , {A}_{1} ) = 1 - sim ( {A}_{k} , {A}_{1} )$$

where, A₁ is an attention feature, l_{div} is a divergence regularization calculation result, and sim is a similarity calculation function.

Furthermore, the regularization loss is:

The feature maps with different scales are extracted from the branch networks, the divergence loss is calculated according to the divergence regularization term, the branch networks are optimized by the divergence loss, and a loss function is shown as follows:

$${L}_{reg} = \frac{1}{3} {\sum }_{k = 1}^{3} ( \frac{1}{2} {\sum }_{l = 1}^{2} {l}_{div} ( {A}_{k} , {A}_{l} ) )$$

Wherein the performing cross-scale spatial map fusion on the multi-scale feature maps by the bilateral local attention mechanism is specifically as follows:
a large-scale feature map is transformed into one with a matched size:

f̅ₜ̅^̅{̅l̅}̅=w_{c}·P(fₜ^{l})
where, P represents a maximum pooling operation with an interval of 2, and w_{c} is a parameter of convolution;
sizes of the large-scale feature map and the mesoscale feature map are matched, and large-scale information and mesoscale information are fused in a feature map averaging manner to obtain a fused feature map {Fₜ∈R^{C×H×W}}ₜ₌₁^{T}; and
the fused feature map is locally decomposed, Fₜ at each moment is evenly decomposed into h*w sub-regions, and average pooling is performed in the sub-regions to obtain a final fused feature map.

Wherein the calculating the prediction loss by the global feature description map is specifically as follows:
time sequence weights are generated by the decomposed feature maps, and a global feature representation u∈R^{C×1} is generated; a channel selection weight is generated according to the global feature representation u:
the feature maps are transformed according to the channel selection weight to acquire the global feature map, and the prediction loss is calculated by the transformed global feature map:

$${L}_{pre} = {\sum }_{t = 1}^{K} {\sum }_{( m , n ) ∈ {Grids}_{output}} {( {G}_{t} ( m , n ) - S S {T}_{t} ( m , n ) )}^{2}$$

where, m is a subscript of horizontal coordinates, n is a subscript of vertical coordinates, SST is a real tag value at a moment t, and Gridsₒᵤₜₚᵤₜ is the traversal of coordinates of two-dimensional output.

It should be noted here that the description of the device in the above embodiment corresponds to that of the method in the embodiment, which is not repeated in the embodiment of the present disclosure.

An executing main body of the processor 1 and the memory 2 may be a computer, a single-chip microcomputer, a microcontroller and other devices with computing functions. The executing main body is not limited to the embodiment of the present disclosure during specific implementation, which is selected according to requirements in actual application.

The memory 2 and the processor 1 transmit data signals through a bus 3, which is not repeated in the embodiment of the present disclosure.

Based on the same inventive concept, an embodiment of the present disclosure further provides a computer-readable storage medium including stored programs, and when the programs run, equipment where the storage medium is located is controlled to implement the steps of the method in the above embodiment.

The computer-readable storage medium includes but is not limited to a flash memory, a hard disk, a solid state disk and the like.

It should be noted here that the description of the readable storage medium in the above embodiment corresponds to that of the method in the embodiment, which is not repeated in the embodiment of the present disclosure.

In the above embodiment, the implementation may be achieved in whole or in part by software, hardware, firmware, or any combination thereof. When achieved by the software, the implementation may be achieved in whole or in part in the form of a computer program product. The computer program product includes one or more computer instructions. When the computer program instructions are loaded and executed on a computer, flows or functions of the embodiment of the present disclosure are generated in whole or in part.

The computer may be a general-purpose computer, a special-purpose computer, a computer network or other programmable devices. The computer instructions may be stored in the computer-readable storage medium or transmitted through the computer-readable storage medium. The computer-readable storage medium may be any available medium capable of being accessed by the computer or data storage equipment such as a server and a data center, which incorporates one or more available media. The available medium may be a magnetic medium or a semiconductor medium and the like.

The embodiment of the present disclosure does not limit models of other devices except for those specifically specified, as long as the devices can complete the above functions.

Those skilled in the art can understand that a drawing is only a schematic diagram of a preferred embodiment. The serial number of the above embodiments of the present disclosure is merely provided for description, and does not represent the advantages and disadvantages of the embodiments.

The above descriptions are merely preferred embodiments of the present disclosure, which are not intended to limit the present disclosure. Any modification, equivalent replacement and improvement made within the spirit and principle of the present disclosure should fall within the scope of protection of the present disclosure.

1. A tropical instability wave early warning method based on temporal-spatial cross-scale attention fusion, comprising the following steps:
up-sampling and down-sampling temporal-spatial data of sea surface temperatures by convolutional and deconvolutional networks based on two-dimensional sea surface temperature images at all moments and all positions to generate multi-scale spatial data;
inputting the multi-scale spatial data into corresponding branch networks to calculate feature maps under corresponding scales, and calculating a regularization loss;
performing cross-scale spatial map fusion on the multi-scale feature maps by a bilateral local attention mechanism, generating a global feature description map, calculating a prediction loss by the global feature description map, and combining the prediction loss and the regularization loss for optimization training of neural networks; and
predicting a sea surface temperature at a moment T based on the optimally trained neural networks, selecting data at K moments before the moment T and inputting the data into the optimally trained neural networks, outputting a predicted value of tropical instability waves by the optimally trained neural networks, and drawing a temporal-spatial image of the tropical instability waves by associating the predicted value with coordinates, so as to achieve early warning of the tropical instability waves.

2. The tropical instability wave early warning method based on temporal-spatial cross-scale attention fusion according to claim 1, wherein the inputting the multi-scale spatial data into the corresponding branch networks to calculate the feature maps under the corresponding scales is specifically as follows:
constructing multi-scale feature network branches, extracting a spatial feature map from each branch network, and each branch network CNNₖ consisting of five layers of convolutional neural networks, containing three convolutional layers, a maxpooling operation and a multilayer perceptron module; wherein
the three convolution layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.

3. The tropical instability wave early warning method based on temporal-spatial cross-scale attention fusion according to claim 1, wherein the performing cross-scale spatial map fusion on the multi-scale feature maps by the bilateral local attention mechanism is specifically as follows:
constructing a cross-scale attention mechanism to reduce redundant information among feature maps with different scales, generating an attention Aₖ by a softmax layer, and increasing divergence among attentions with different scales by a divergence regularization term, wherein a formula of the divergence regularization term is as follows:
$${A}_{k} = softmax ( \frac{1}{C} {\sum }_{c = 1}^{C} {f}_{t}^{k} )$$
$${l}_{div} ( {A}_{k} , {A}_{1} ) = 1 - sim ( {A}_{k} , {A}_{1} )$$
where, A₁ is an attention feature, l_{div} is a divergence regularization calculation result, and sim is a similarity calculation function.

4. The tropical instability wave early warning method based on temporal-spatial cross-scale attention fusion according to claim 3, wherein the regularization loss is:
extracting the feature maps with different scales from the branch networks, calculating the divergence loss according to the divergence regularization term, optimizing the branch networks by the divergence loss, and a loss function being shown as follows:
L_{reg}=⅓Σₖ₌₁³(½Σₗ₌₁²l_{div}(Aₖ, Aₗ)).

5. The tropical instability wave early warning method based on temporal-spatial cross-scale attention fusion according to claim 4, wherein the performing cross-scale spatial map fusion on the multi-scale feature maps by the bilateral local attention mechanism is specifically as follows:
transforming a large-scale feature map into one with a matched size:
f̅ₜ̅^̅{̅l̅}̅=w_{c}·P(fₜ^{l})
where, P represents a maxpooling operation at an interval of 2, and w_{c} is a parameter of convolution;
matching sizes of the large-scale feature map and the mesoscale feature map, and fusing large-scale information and mesoscale information in a feature map averaging manner to obtain a fused feature map {Fₜ∈R^{C×H×W}}ₜ₌₁^{T}; and
locally decomposing the fused feature map, evenly decomposing Fₜ at each moment into h*w sub-regions, and performing average pooling in the sub-regions to obtain a final fused feature map.

6. The tropical instability wave early warning method based on temporal-spatial cross-scale attention fusion according to claim 1, wherein the calculating the prediction loss by the global feature description map is specifically as follows:
generating time sequence weights by the decomposed feature maps, and generating a global feature representation u∈R^{C×1}; generating a channel selection weight according to the global feature representation u:
transforming the feature maps according to the channel selection weight to acquire the global feature map, and calculating the prediction loss by the transformed global feature map:
$${L}_{pre} = {\sum }_{t = 1}^{K} {\sum }_{( m , n ) ∈ {Grids}_{output}} {( {G}_{t} ( m , n ) - S S {T}_{t} ( m , n ) )}^{2}$$
where, m is a subscript of horizontal coordinates, n is a subscript of vertical coordinates, SST is a real tag value at a moment t, Gridsₒᵤₜₚᵤₜ is the traversal of coordinates of two-dimensional output, and Gₜ is the global feature map.

7. A tropical instability wave early warning device based on temporal-spatial cross-scale attention fusion, comprising:
a module for generating multi-scale spatial data, configured to up-sample and down-sample temporal-spatial data of sea surface temperatures by convolutional and deconvolutional networks based on two-dimensional sea surface temperature images at all moments and all positions to generate the multi-scale spatial data;
a module for calculating a regularization loss, configured to input the multi-scale spatial data into corresponding branch networks to calculate feature maps under corresponding scales, and calculate the regularization loss;
an optimization training module, configured to perform cross-scale spatial map fusion on the multi-scale feature maps by a bilateral local attention mechanism, generate a global feature description map, calculate a prediction loss by the global feature description map, and combine the prediction loss and the regularization loss for optimization training of neural networks; and
a module for early warning of tropical instability waves, configured to predict a sea surface temperature at a moment T based on the optimally trained neural networks, select data at K moments before the moment T and input the data into the optimally trained neural networks, output a predicted value of the tropical instability waves by the optimally trained neural networks, and draw a temporal-spatial image of the tropical instability waves by associating the predicted value with coordinates, so as to achieve early warning of the tropical instability waves.

8. A tropical instability wave early warning device based on temporal-spatial cross-scale attention fusion, further comprising a processor and a memory, wherein
program instructions are stored in the memory, and the processor calls the program instructions stored in the memory to enable the device to implement the steps of the method according to claim 1.

9. A computer-readable storage medium storing computer programs, wherein the computer-readable storage medium storing computer programs, the computer programs comprise program instructions, and when the program instructions are executed by a processor, the processor implements the steps of the method according to claim 1.

10. The tropical instability wave early warning device of claim 8, wherein the inputting the multi-scale spatial data into the corresponding branch networks to calculate the feature maps under the corresponding scales is specifically as follows:
constructing multi-scale feature network branches, extracting a spatial feature map from each branch network, and each branch network CNNₖ consisting of five layers of convolutional neural networks, containing three convolutional layers, a maxpooling operation and a multilayer perceptron module; wherein
the three convolution layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.

11. The tropical instability wave early warning device of claim 8, wherein the performing cross-scale spatial map fusion on the multi-scale feature maps by the bilateral local attention mechanism is specifically as follows:
constructing a cross-scale attention mechanism to reduce redundant information among feature maps with different scales, generating an attention Aₖ by a softmax layer, and increasing divergence among attentions with different scales by a divergence regularization term, wherein a formula of the divergence regularization term is as follows:
$${A}_{k} = softmax ( \frac{1}{C} {\sum }_{c = 1}^{C} {f}_{t}^{k} )$$
$${l}_{div} ( {A}_{k} , {A}_{1} ) = 1 - sim ( {A}_{k} , {A}_{1} )$$
where, A₁ is an attention feature, l_{div} is a divergence regularization calculation result, and sim is a similarity calculation function.

12. The tropical instability wave early warning device of claim 11, wherein the regularization loss is:
extracting the feature maps with different scales from the branch networks, calculating the divergence loss according to the divergence regularization term, optimizing the branch networks by the divergence loss, and a loss function being shown as follows:
L_{reg}=⅓Σₖ₌₁³(½Σₗ₌₁²l_{div}(Aₖ, Aₗ)).

13. The tropical instability wave early warning device of claim 12, wherein the performing cross-scale spatial map fusion on the multi-scale feature maps by the bilateral local attention mechanism is specifically as follows:
transforming a large-scale feature map into one with a matched size:
f̅ₜ̅^̅{̅l̅}̅=w_{c}·P(fₜ^{l})
where, P represents a maxpooling operation at an interval of 2, and w_{c} is a parameter of convolution;
matching sizes of the large-scale feature map and the mesoscale feature map, and fusing large-scale information and mesoscale information in a feature map averaging manner to obtain a fused feature map {Fₜ∈R^{C×H×W}}ₜ₌₁^{T}; and
locally decomposing the fused feature map, evenly decomposing Fₜ at each moment into h*w sub-regions, and performing average pooling in the sub-regions to obtain a final fused feature map.

14. The tropical instability wave early warning device of claim 8, wherein the calculating the prediction loss by the global feature description map is specifically as follows:
generating time sequence weights by the decomposed feature maps, and generating a global feature representation u∈R^{C×1}; generating a channel selection weight according to the global feature representation u:
transforming the feature maps according to the channel selection weight to acquire the global feature map, and calculating the prediction loss by the transformed global feature map:
$${L}_{pre} = {\sum }_{t = 1}^{K} {\sum }_{( m , n ) ∈ {Grids}_{output}} {( {G}_{t} ( m , n ) - S S {T}_{t} ( m , n ) )}^{2}$$
where, m is a subscript of horizontal coordinates, n is a subscript of vertical coordinates, SST is a real tag value at a moment t, Gridsₒᵤₜₚᵤₜ is the traversal of coordinates of two-dimensional output, and Gₜ is the global feature map.

15. The computer-readable storage medium of claim 9, wherein the inputting the multi-scale spatial data into the corresponding branch networks to calculate the feature maps under the corresponding scales is specifically as follows:
constructing multi-scale feature network branches, extracting a spatial feature map from each branch network, and each branch network CNNₖ consisting of five layers of convolutional neural networks, containing three convolutional layers, a maxpooling operation and a multilayer perceptron module; wherein
the three convolution layers are all two-dimensional convolution operations, and output dimensions thereof are 1024*1024, 512*512 and 256*256 respectively; a size of a kernel of maxpooling is 4*4; and the multilayer perceptron module consists of a kernel ReLU activation function of a fully connected layer, the ReLU function is ReLU (x)=max (x, 0), where, max is a maximum function.

16. The computer-readable storage medium of claim 9, wherein the performing cross-scale spatial map fusion on the multi-scale feature maps by the bilateral local attention mechanism is specifically as follows:
constructing a cross-scale attention mechanism to reduce redundant information among feature maps with different scales, generating an attention Aₖ by a softmax layer, and increasing divergence among attentions with different scales by a divergence regularization term, wherein a formula of the divergence regularization term is as follows:
$${A}_{k} = softmax ( \frac{1}{C} {\sum }_{c = 1}^{C} {f}_{t}^{k} )$$
$${l}_{div} ( {A}_{k} , {A}_{1} ) = 1 - sim ( {A}_{k} , {A}_{1} )$$
where, A₁ is an attention feature, l_{div} is a divergence regularization calculation result, and sim is a similarity calculation function.

17. The computer-readable storage medium of claim 16, wherein the regularization loss is:
extracting the feature maps with different scales from the branch networks, calculating the divergence loss according to the divergence regularization term, optimizing the branch networks by the divergence loss, and a loss function being shown as follows:
L_{reg}=⅓Σₖ₌₁³(½Σₗ₌₁²l_{div}(Aₖ, Aₗ)).

18. The computer-readable storage medium of claim 17, wherein the performing cross-scale spatial map fusion on the multi-scale feature maps by the bilateral local attention mechanism is specifically as follows:
transforming a large-scale feature map into one with a matched size:
f̅ₜ̅^̅{̅l̅}̅=w_{c}·P(fₜ^{l})
where, P represents a maxpooling operation at an interval of 2, and w_{c} is a parameter of convolution;
matching sizes of the large-scale feature map and the mesoscale feature map, and fusing large-scale information and mesoscale information in a feature map averaging manner to obtain a fused feature map {Fₜ∈R^{C×H×W}}ₜ₌₁^{T}; and
locally decomposing the fused feature map, evenly decomposing Fₜ at each moment into h*w sub-regions, and performing average pooling in the sub-regions to obtain a final fused feature map.

19. The computer-readable storage medium of claim 9, wherein the calculating the prediction loss by the global feature description map is specifically as follows:
generating time sequence weights by the decomposed feature maps, and generating a global feature representation u∈R^{C×1}; generating a channel selection weight according to the global feature representation u:
transforming the feature maps according to the channel selection weight to acquire the global feature map, and calculating the prediction loss by the transformed global feature map:
$${L}_{pre} = {\sum }_{t = 1}^{K} {\sum }_{( m , n ) ∈ {Grids}_{output}} {( {G}_{t} ( m , n ) - S S {T}_{t} ( m , n ) )}^{2}$$
where, m is a subscript of horizontal coordinates, n is a subscript of vertical coordinates, SST is a real tag value at a moment t, Gridsₒᵤₜₚᵤₜ is the traversal of coordinates of two-dimensional output, and Gₜ is the global feature map.
